(19) United States
(12) Patent Application Publication
(10) Pub. No.: US 2012/0059640 A1
(43) Pub. Date: Mar. 8, 2012

(54) THERMODYNAMIC MODELING FOR OPTIMIZED RECOVERY IN SAGD

(75) Inventors: Indranil Roy, Sugar Land, TX (US); Chris Wilkinson, Houston, TX (US); Colin Longfield, Sugar Land, TX (US); Oliver C. Mullins, Ridgefield, CT (US); Richard E. Lewis, Edmond, OK (US)

(73) Assignee: SCHLUMBERGER TECHNOLOGY CORPORATION, SUGAR LAND, TX (US)

(21) Appl. No.: 13/223,029

(22) Filed: Aug. 31, 2011

Related U.S. Application Data
(60) Provisional application No. 61/379,528, filed on Sep. 2, 2010.

(51) Int. Cl. G06G 7/48

(52) U.S. Cl. 703/10

(57) ABSTRACT

One or more computer-readable media include computer-executable instructions to instruct a computing system to receive input as to physical characteristics of a resource recovery system and a resource reservoir; simulate fluid thermodynamics of the system and the reservoir; and output information as to phase composition, for example, in at least one dense phase affected by the resource recovery system. Various other apparatuses, systems, methods, etc., are also disclosed.

### RELATED APPLICATIONS

This application claims the benefit of U.S. Provisional Application having Ser. No. 61/379,528, entitled “METHOD TO USE THERMODYNAMIC MODELING FOR OPTIMIZED RECOVERY IN SAGD” filed Sep. 2, 2010, which is incorporated by reference herein.

### BACKGROUND

Steam-Assisted Gravity Drainage (SAGD) is a technique that involves subterranean delivery of steam to enhance flow of heavy oil, bitumen, etc. SAGD can be applied for Enhanced Oil Recovery (EOR), which is also known as tertiary recovery because it changes properties of oil in situ.

A conventional SAGD technique applied for EOR may involve a pair of wells where steam is delivered to an upper well to reduce viscosity of neighboring oil to enhance drainage of the oil, as influenced by gravity, to a lower well. As condensed steam typically accompanies the oil to the lower well, SAGD can increase demands on separation processing where it is desirable to separate one or more components from the oil and water mixture.

SAGD may be implemented through use of a downhole steam generator. Where a downhole steam generator relies on combustion (e.g., a burner), a source may be natural gas. For example, a downhole steam generator may be configured to receive natural gas, air and water, to combust a mixture of the natural gas and the air, and to direct combustion heat to the water to generate steam.

As an example, consider a downhole steam generator fed by three separate streams of natural gas, air and water. The gas-air mixture is combined first to create a flame and then the water is injected downstream to create steam. In such an example, the water can also serve to cool a burner wall or walls (e.g., by flowing in a passageway or passageways within a wall). Mechanically, a burner may be located at the bottom of a temporary completion with either two or three strings of tubing. In a dual tubing example, water may flow in annulus of a case that surrounds the two tubes.

Due to environmental, operational or both environmental and operational conditions, a downhole steam generator may degrade and have a limited lifetime (e.g., before replacement or servicing). For example, a downhole steam generator with a burner may have a downhole operational period of about 3 months to about 12 months or possibly more. Further, inherently, a downhole steam generator affects environmental conditions and, where a combustor is implemented, combustion products may contact oil (e.g., directly or indirectly through entrainment in steam, condensation with steam, condensate, etc.). In this regard, SAGD implemented by a combustor can increase demands on separation processing where it is desirable to separate one or more components from the oil, water, combustion component mixture.

In various examples, techniques and technologies are described herein that can facilitate resource recovery using SAGD, for example, whether SAGD is implemented using combustion or another energy source (e.g., electrical, etc.).

### SUMMARY

As described herein, a system can be configured to receive input as to physical characteristics of a resource recovery system and a resource reservoir, to simulate fluid thermodynamics of the resource recovery system and the resource reservoir, and to output information as to phase composition, for example, affected by the resource recovery system. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example modeling system that includes a reservoir simulator, a data mining hub and a SAGD/Thermodynamics module;

FIG. 2 illustrates an example of an environment with a reservoir field with a steam well and a resource production well and an example of plotted information pertaining to resource production;

FIG. 3 illustrates an example of equipment for downhole steam generation;

FIG. 4 illustrates examples of modules for simulation of SAGD and thermodynamics;

FIG. 5 illustrates an example of a method for outputting information based on a thermodynamic model or models;

FIG. 6 illustrates an example of a method for outputting information as to phases and phase composition for a heavy oil and SAGD system;

FIG. 7 illustrates an example of a method for outputting information as to use of sour gas for generating steam;

FIG. 8 illustrates an example of systems of equations for modeling various phenomena;

FIG. 9 illustrates an example of a field scenario that relies, at least in part, on information output from a computing system; and

FIG. 10 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As described herein, various techniques and technologies can facilitate resource recovery using SAGD, for example, whether SAGD is implemented using combustion or another energy source (e.g., electrical, etc.). For example, where SAGD is implemented using combustion, one or more modules may be configured to model phenomena such as flow, phase, and reaction phenomena. Such modeled phenomena may be germane to any of a variety of factors related to resource recovery.

As described herein, modeled reaction phenomena can provide for tailoring design specifications of equipment or setting or predicting service life of equipment. As an example, consider reactions that cause corrosion, especially due to combustion products that may be combined with steam. Depending on any of a variety of operational constraints for recovery of a resource, model results may indicate that a downhole burner be constructed from a nickel corrosion resistant alloy (e.g., consider a NICROFER® nickel-iron-chromium alloy as marketed by ThyssenKrupp VDM GmbH and containing molybdenum, copper, titanium and aluminum and having resistance to corrosion and sulfide stress cracking and high strength to temperatures of 550 C). Further, such results may indicate that other recovery equipment components be treated for chemical protection. As another example, results from modeled phenomena may indicate a lifetime of one or more seal components. In such an example, sensed information may optionally be acquired during a period or periods of operation and input to a computing system to provide for an estimate of lifetime of a “weakest link” seal component (e.g., consider an estimate of a replacement time based on tolerances, etc., of a seal component).

Where options exist for combustion-based steam generation and another type of steam generation, one or more modules may include instructions for execution by a computing system to provide a comparison between the two different types of steam generation or optionally to provide results for hybrid steam generation (e.g., co-generation, periods of combustion, periods of electrical, etc.). Yet further, for combustion-based steam generation, modules can be provided for various types of sources (e.g., carbon, hydrogen, etc.) and optionally contaminants therein. For example, so-called sweet gas and sour gas options may be provided (e.g., in the field, sour gas may be readily available as vent gas, however, burning of sour gas can introduce additional constraints). Given such options, a computing system can provide information as to requirements and performance of steam generation for facilities for sweet gas and sour gas. Where sensed information is available, such information (e.g., H₂S, SO₂, O₂, CO₂, pH, moisture, temperature, pressure, flow, vibration, or other) may be input to a computing system to simulate a field operation and then provide guidance for operation of a downhole burner to generate steam (e.g., optionally input to a burner control unit). As described herein, such an approach may be coupled with a module that accounts for materials of construction of piping, fittings, seals, etc., to determine consequences of sweet gas as a carbon source and sour gas as a carbon source. Further, sensors may be impacted by carbon source or other operational conditions. For example, optical fiber sensors may be impacted by harsh environmental conditions (e.g., physical integrity, loss of signal, etc.); accordingly, a module may provide information to assess sensor performance, physical degradation, lifetime, etc., or to select specifications for sensors in various modeled environmental regions.

While sour gas has been mentioned in comparison to sweet gas as to a carbon source for a burner, one or more modules may allow for comparisons as to cooling sources. For example, a comparison may be made between fresh water and salt water, particularly for cooling a downhole burner or equipment that may be heated by operation of a downhole burner.

As described herein, one or more modules can include instructions for execution by a computing system to provide results germane to heavy oil mobility, which may be dramatically reduced upon a decrease in temperature. For example, where SAGD is applied to increase temperature and reduce viscosity of heavy oil, subsequent cooling of the heavy oil can plug surface flow lines and test equipment, whether uphole or downhole (e.g., or more generally proximately or distally). Field experience indicates that heavy oil can solidify in pipes as it cools, at surface or even downhole, for example, if the well is lifted with nitrogen as provided through coil tubing.

In general, conventional techniques for determining fluid properties of typical oil do not work very well with heavy oil. Inaccurate measurements of fluid properties may lead to inaccurate rate measurements obtained through multiphase flow meters. Therefore, techniques and technologies that can provide for identification and breakup of water emulsions in heavy oil can be quite beneficial, for example, to arrive at accurate rate measurements. As described herein, one or more modules may include instructions executable via a computing system to model phenomena and to provide results as to aqueous emulsions in oil (e.g., heavy oil that may be subject to substantial increases in viscosity upon cooling).

As described herein, a computing system can be configured (e.g., via circuitry, one or more modules, etc.) to use thermodynamic modeling to characterize a heavy oil reservoir through phase compositions in pore spaces. Such a system may be configured to (1) predict viscosity and interaction parameters post stimulation with (a) steam or (b) other injection fluid and (2) predict associated metallurgy and scale stability from one or more of the interaction parameters and also (3) predict aspects of injection fluid(s) to abet a stimulation of a heavy oil reservoir and formation of an emulsion that can be readily transferred from downhole to the surface (e.g., with reduced risk of cooling and plugging). In the foregoing example, individual modules may include instructions for execution by one or more processors to model one or more phenomena and optionally to predict viscosity, stability, injection parameters, etc. For example, one module may provide for viscosity information, another module for scale stability information, another module for corrosion information, and yet another module for phase information (e.g., emulsion formation). Such modules may be configured to interact (e.g., to share information), for example, where a result of one module depends on a result of another (e.g., consider scale stability and corrosion). As described herein, results from such a computing system can optionally be relied upon, whether manually or via input to one or more other computing systems, to help successfully harness, develop, complete and safely produce heavy oil from reservoirs. In particular, where sour gas is relied on as a carbon source for combustion in a burner for steam generation, results from such a computing system can be quite beneficial.

As described herein, thermodynamic modeling can predict vapor-liquid equilibrium (VLE)/liquid-liquid equilibrium (LLE) phase compositions in heavy oil reservoirs and interaction parameters, for example, consider aqueous phase/dense oil activities, steam and dense phase fugacities, pH, DC conductivity, viscosity, mobilities, dew and bubble points, etc., based at least in part on bottomhole conditions. In general, equilibrium compositions of multiphase fluids (e.g., water, steam, dense gas and heavy oil) can help in better characterization of a downhole reservoir system; and phase equilibrium data and chemical compositions can enable more accurate predictions for production and reserves.

As described herein, modeling can provide for metallurgical predictions for life cycle of one or more components associated with a well, for example, where such predictions can be made from interaction parameters. As described herein, modeling can provide for predictions as to scale stability and optionally usage of and types of inhibitors that aim to prevent scaling (e.g., deposition of material on surfaces).

As described herein, modeling can provide for predictions as to lifting of heavy oil, optionally as an emulsion. Such modeling may provide for economization that accounts for factors such as prevention of deposition and prevention of solidification. As mentioned, various techniques can provide for prediction of types, amounts, etc., of fluid to be injected, for example, to abet stimulation of the heavy oil reservoir and formation of an emulsion that can be easily transferred from downhole to the surface.

As described herein, various models can provide for prediction of equilibrium compositions of multiphase fluids, for example, to help better characterize a downhole heavy oil reservoir system through thermodynamic modeling. For example, for SAGD and HT wells, one or more modules may provide instructions for execution by a computing system to provide equilibrium compositions of multiphase fluids in a manner that accounts for relevant thermodynamics. In general, thermodynamic modeling allows for generation of phase equilibrium data and chemical composition data that can be beneficial for more accurately predicting production and reserves.

As described herein, thermodynamic modeling, as implemented via one or more modules, can provide information to help prevention of deposition or solidification of heavy oil (e.g., optionally as an emulsion) during lifting. As described herein, thermodynamic model predictions can optionally be regressed to actual field data, lab data, etc. As described herein, one or more modules may provide for training of a model based on input, feedback, etc., (e.g., actual data) to help make more intelligent predictions.

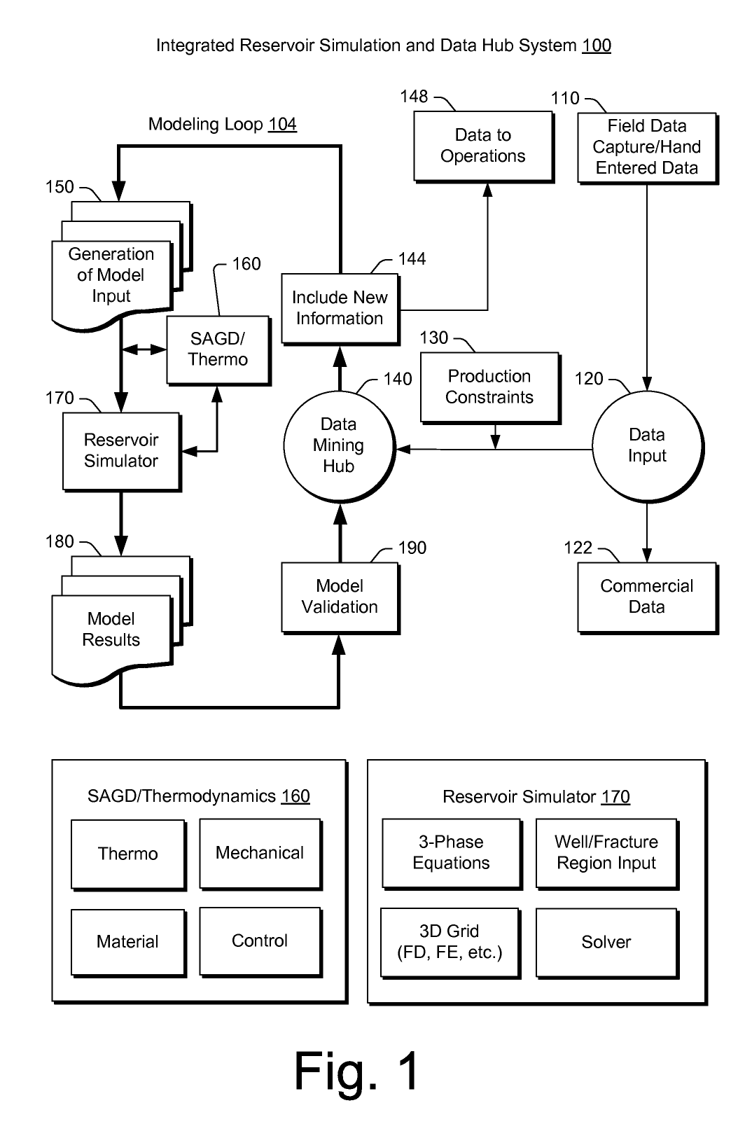

FIG. 1 shows an integrated reservoir simulation and data hub system 100. The system 100 includes a modeling loop 104 composed of various modules configured to receive and generate information. In a typical operational process, the system 100 receives, at a field data block 110, field data about a reservoir, which may be captured electronically via one or more data acquisition techniques, gathered “by hand” through observation or reporting, etc. The field data block 110 transmits the received data to a data input 120 configured to input data to the modeling loop 104. The data input 120 may also provide some of the received field data to a commercial data block 122 (e.g., for any of a variety of commercial purposes such as financial modeling).

The system 100 includes a production constraints block 130, which may provide information, for example, related to production equipment (e.g., pumps, piping, operational energy costs, etc.). The modeling loop 104 receives information via a data mining hub 140. As noted this information can include data from the data input 120 as well as information from the production constraints block 130. The data mining hub 140 may rely at least in part on a commercially available package or set of modules that execute on one or more computing devices. For example, a commercially available package marketed as the DECIDE!® oil and gas workflow automation, data mining and analysis software (Schlumberger Limited, Houston, Tex.) may be used to provide at least some of the functionality of the data mining hub 140.

The DECIDE!® software provides for data mining and data analysis (e.g., statistical techniques, neural networks, etc.). A particular feature of the DECIDE!® software, referred to as Self-Organizing Maps (SOM), can assist in model development, for example, to enhance reservoir simulation efforts. The DECIDE!® software further includes monitoring and surveillance features that, for example, can assist with data conditioning, well performance and underperformance, liquid loading detection, drawdown detection and well downtime detection. Yet further, the DECIDE!® software includes various graphical user interface modules that allow for presentation of results (e.g., graphs and alarms). While a particular commercial software product is mentioned with respect to various data hub features, as discussed herein, a system need not include all such features to implement various techniques.

Referring again to the modeling loop 104 of FIG. 1, the data mining hub 140 acts to include new information per block 144; noting that some or all of such data may be transmitted to a data to operations block 148 (e.g., for use in the field, etc.). The loop 104 relies on the new information of block 144 to generate model input in a generation block 150. For example, the generation block 150 may adjust one or more parameters of a mathematical model of a reservoir (e.g., optionally including additional geological structure, types of wells, etc.) based at least in part on the new information.

In the system 100, a SAGD/thermodynamics block 160 may provide input to the reservoir simulator along with the model input per the block 150. The reservoir simulator 170 may rely at least in part on a commercially available package or set of modules that execute on one or more computing devices. For example, a commercially available package marketed as the ECLIPSE® reservoir engineering software (Schlumberger Limited, Houston, Tex.) may be used to provide at least some of the functionality of the reservoir simulator 170.

The ECLIPSE® software relies on a finite difference technique, which is a numerical technique that discretizes a physical space into blocks defined by a multidimensional grid. Numerical techniques (e.g., finite difference, finite element, etc.) typically use transforms or mappings to map a physical space to a computational or model space, for example, to facilitate computing. Numerical techniques may include equations for heat transfer, mass transfer, phase change, etc. Some techniques rely on overlaid or staggered grids or blocks to describe variables, which may be interrelated. While the finite difference is mentioned, a finite element approach may include a finite difference approach for time (e.g., to iterate forward or backward in time). As shown in FIG. 1, the reservoir simulator 170 includes equations to describe 3-phase behavior (e.g., liquid, gas, gas in solution), well and/or fracture region input, a 3D grid feature to discretize a physical space and a solver to solve models.

As to the SAGD/thermodynamics block 160, depending on the approach selected or implemented, the block 160 may provide a thermodynamic model, a mechanical model, a material model (e.g., of construction), and a SAGD or other process control model. As described herein, the SAGD/thermodynamics block 160 can provide capabilities to supplement, replace or otherwise enhance capabilities of the reservoir simulator 170. For example, the reservoir simulator 170 may have rudimentary capabilities as to 3-phase systems, which are suboptimal for simulating scenarios that may include SAGD. Accordingly, the SAGD/thermodynamics block 160 may provide various models to more accurate model a SAGD scenario or other scenario (e.g., optionally not including SAGD).

As described herein, the SAGD/thermodynamics block 160 may be provided as an add-on to a commercially available simulator. Such an add-on may be configured to execute locally with a commercial simulator or may be configured to execute, at least in part, remotely (i.e., remote from the commercial simulator). As an example, consider a remote server in communication with a network and configured with instructions executable on one or more processors to effectuate one or more of the models of the block 160. In such a manner, access to extended capabilities (e.g., whether specialized, proprietary, etc.) may be achieved, especially where SAGD is an option for EOR.

As described herein, one or more application programming interfaces (APIs) may be provided that allow for calls and returns between executing modules. As an example, consider an API that allows the reservoir simulator 170 to make calls to the SAGD/thermodynamic block 160. In such an example, the reservoir simulator 170 may provide an option to a user to implement the block 160 such that during execution, the simulator makes calls to the block 160, passing appropriate information (e.g., depth information, resource information, etc.). In turn, the block 160 performs calculations based at least in part on the passed information and returns relevant results to the simulator 170. In the foregoing example, or other examples, the block 160 may be configured to make calls to the simulator 170 via an API. Accordingly, information may be passed between the block 160 and the simulator 170.

As shown in FIG. 1, the reservoir simulator 170 provides results 180 based on at least in part on a reservoir model. Per a validation block 190, the results 180 may be validated, for example, by comparison to acquired physical data for the reservoir, wells, fractures, SAGD data, etc. The loop 104 may continue iteratively as new data is introduced via the data mining hub 140.

In the example of FIG. 1, the system 100 may be implemented for any of a variety of workflows and may involve use of commercially available software (e.g., consider one or more of ECLIPSE®, DECIDE!, PETREL®, and the OCEAN® framework marketed by Schlumberger Limited, Houston, Tex.).

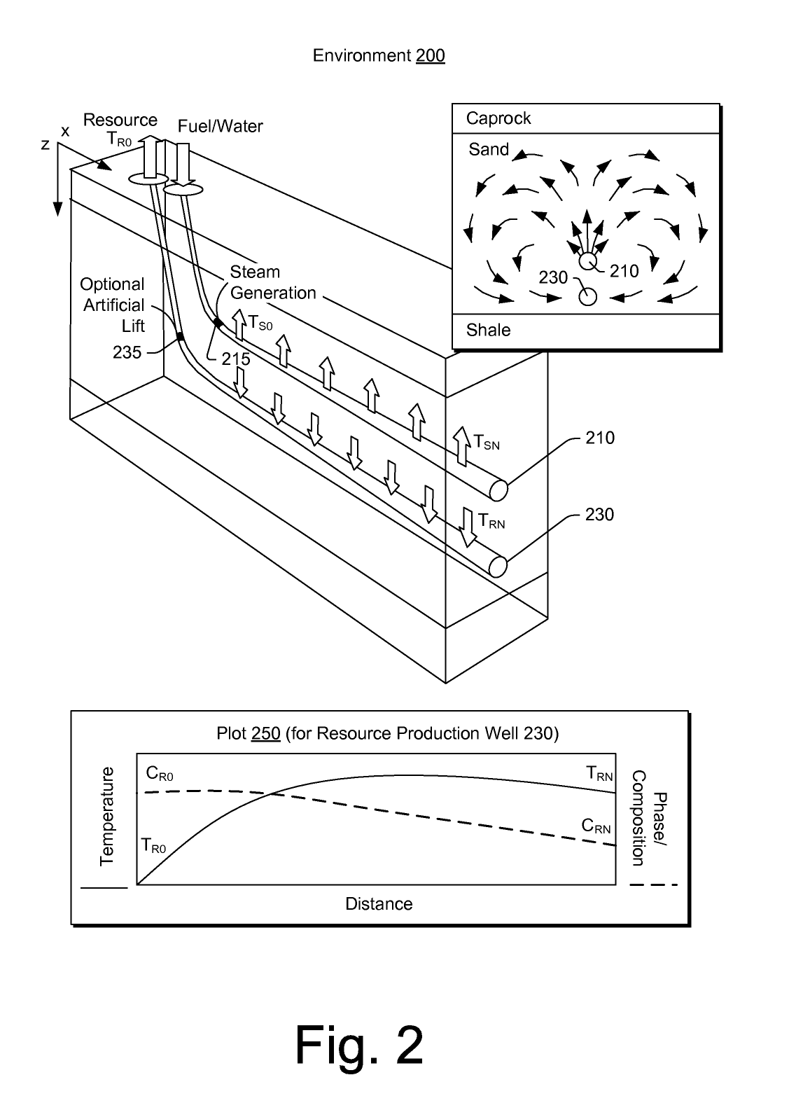

FIG. 2 shows an example of an environment 200 that includes a steam-injection well 210 and a resource production well 230 as well as an example of a plot of information 250. In the example of FIG. 2, a downhole steam generator 215 generates steam in the injection well 210, for example, based on supplies of water and fuel from surface conduits, and optional artificial lift equipment 235 may be implemented to facilitate resource production. As illustrated in a cross-sectional view, the steam rises in the subterranean portion of the environment 200. As the steam rises, it transfers heat to a desirable resource such as heavy oil. As the resource is heated, its viscosity decreases, allowing it to flow more readily to the resource production well 230.

As to the optional artificial lift equipment 235, such equipment may be, for example, an electrical submersible pump (ESP). An ESP may be configured as a multistage centrifugal pump where, for example, each stage consists of a rotating impeller and a stationary diffuser. Materials of construction of an ESP may include Ni-Resist material, RYTON® material (Chevron Phillips Chemical Company LP, The Woodlands, Tex.), or other materials (e.g., to handle corrosive or abrasive wells). Shafts may be constructed from MONEL® alloy K-500 (Inco Alloys International, Inc., Huntington, W. Va.) or optionally another material. Depending on requirements, components of an ESP may include corrosion-resistant coatings, ferritic steel construction, etc., which may offer some protection in H₂S, CO₂, and similar corrosive environments. As an example, an ESP may be a REDA™ Hotline™, high-temperature pump marketed by Schlumberger Technology Corporation, Houston, Tex. REDA™ Hotline™ high-temperature ESP systems are configured to operate in high temperatures environments such as those occurring in some thermal-recovery heavy oil production applications (e.g., SAGD and steamflooding). In various configurations, gas separators and handlers may be included to maximize drawdown, for example, optionally allowing a system to produce a gas volume fraction of up to about 95%. As to temperatures, some REDA™ Hotline™ ESP systems may, for example, operate with bottomhole/fluid temperatures of up to about 250 C. While ESPs are mentioned, other types of artificial lift or other equipment may be implemented in a resource recovery system.

In the plot 250 for the resource production well 230, temperature as well as phase or composition are plotted versus distance. In this example, distance may be to a surface point of the well 230. As indicated, temperature is at a maximum near a distance along the x-axis that corresponds approximately to the steam generator 215. It is likely that viscosity in the resource production well may be near a minimum at this point; thus, allowing for ease of flow. However, as indicated, temperature decreases in route to the surface. Accordingly, a risk of an increase in viscosity exists as well as changes in phase or composition. For example, should residual steam exist, it may condense in the resource production well. 230 (e.g., giving up any remaining latent heat). Upon condensation, the conditions in the resource production well 230 may be considered as becoming more “wet”. In a scenario where sour gas is used to generate steam, as conditions become more wet, H₂S entrained in the condensing steam may form a strong acid that contacts and degrades equipment. Further, such an acid may have repercussions as to separating a desired resource from the bulk material produced at the surface by the resource production well 230.

As described herein, artificial lift or other equipment may alter conditions. For example, an ESP may alter pressure and impart mechanical energy that impact phase or phases of material traveling in a production well. In such an example, mixing may occur that could impact concentration of a species, which may, in turn, affect corrosion or other characteristics of material traveling in a production well. Accordingly, one or more links may exist between operation of a steam generator and operation of artificial lift equipment.

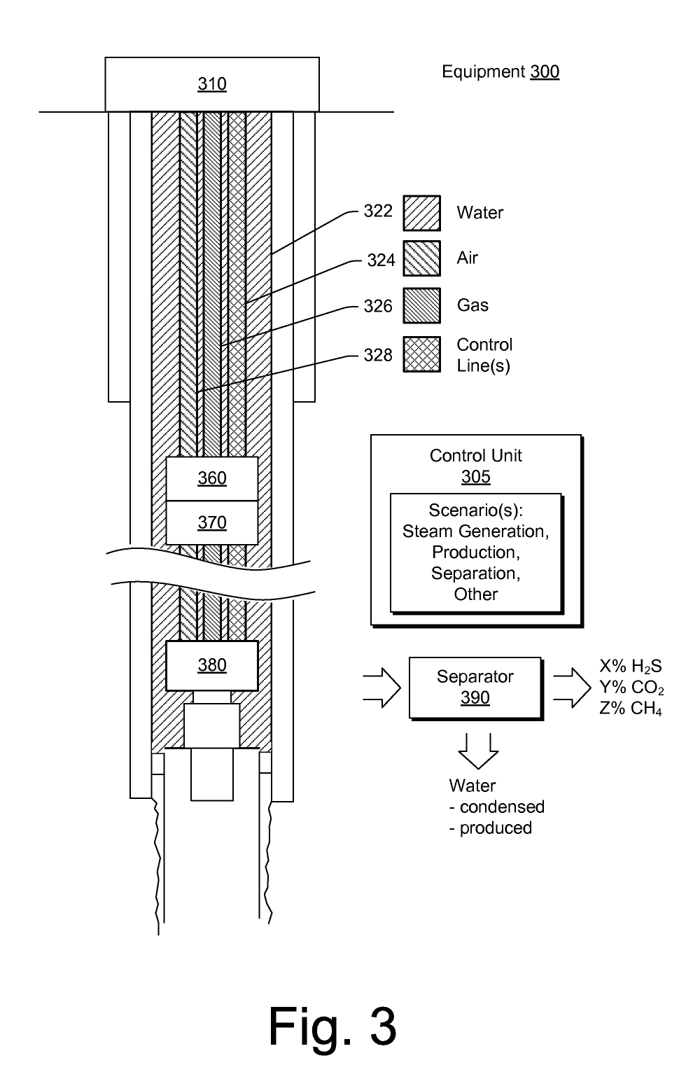

FIG. 3 shows an example of equipment 300 suitable for downhole steam generation for SAGD as a form of EOR. In this example, a well head assembly 310 couples to a downhole assembly that includes various conduits 322, 324, 326 and 328 that may interact with downhole components such as a sensing, control and telemetry unit 360, a flow control unit 370 and a combustor/steam generator unit 380. The conduits are configured to carry water 322, air 324, gas 326 and control line(s) 328. In the example of FIG. 3, the water conduit 322 is configured as an annulus about the conduits 324, 326 and 328. As such, water flowing in the conduit 322 may act to cool the downhole assembly, especially to remove heat as water flows to the combustor/steam generation unit 380. Further, such an arrangement can be beneficial in that heat transferred to the water causes in increase in its temperature and thereby diminishes, somewhat, the energy requirements for steam generation.

As described herein, the equipment 300 typically has a control unit 305 configured for wired, wireless or a combination of wired and wireless control. The control unit 305 is configured with control circuitry, which may be in the form of one or more processors and optionally memory that stores instructions executable by at least one of the processors. As described herein, a control unit may provide for sensing and transmission of sensed information. Such a unit may provide for receipt of sensed information or other information, which, in turn, may be relied on, at least in part, for controlling operation of the equipment 300. As an example, consider a scenario where the control unit 305 receives sensed information as to quality of gas being carried in the conduit 326. In response, the control unit 305 may call for adjusting and optionally actually adjust air/gas mixture to provide for efficient operation of the combustor/steam generation unit 380. As another example, consider a scenario where the control unit 305 receives sensed information as to solidification of heavy oil in an associated resource production well (see, e.g., wells 210 and 230 of FIG. 2). In such a scenario, it may be prudent to increase steam generation. Accordingly, upon receipt of temperature, viscosity, composition or other information as to heavy oil, the control unit 305 may call for increasing and optionally actually increase steam generation (e.g., via increased water flow, increased air and gas flow, etc.). Also shown in FIG. 3 is a separator 390, which may be configured for control by the control unit 305, for example, for separating gases from water, which may be condensed water and produced water. Operation of such a separator may likewise be controlled in response to a change in operation of other equipment (e.g., to account for increase in water attributable to steam, etc.).

As described herein, artificial lift equipment (see, e.g., equipment 235 of FIG. 2) may be associated with a control unit that may provide for receipt and transmission of information. Such a unit may provide for receipt of sensed information or other information, which, in turn, may be relied on, at least in part, for controlling operation of artificial lift equipment. A control unit may optionally be a coordinated control unit configured to control various equipment (e.g., SAGD, artificial lift, etc.).

As to equipment used in a recovery environment, factors such as feed water quality for steam generation, quality of steam generated, composition of combustion gas, combustion conditions, reservoir properties, etc., may be relevant to selection of equipment characteristics and operation of equipment. As an example, consider water with a high concentration of dissolved material. Steam generated using such water can carry these materials, which may, in turn, deposit on equipment surfaces (e.g., due to changes in conditions). Scaling is an example of a common issue associated with heat exchange equipment, which may lead to a reduction in heat exchange, reduction in flow area, alteration in material properties that can enhance corrosion, etc. As described herein, equipment may be present and controllable for treating water, for example, to reduce risk of scaling, corrosion, etc. Such treating may include use of additives for flocculating, filtering, pH control, etc.

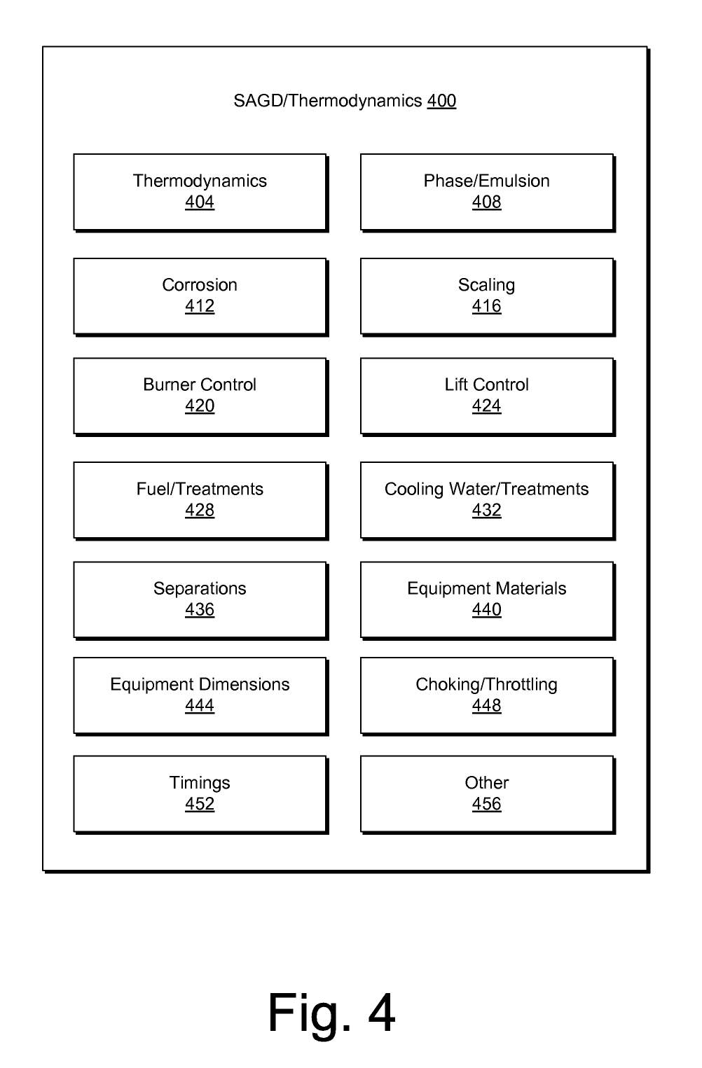

FIG. 4 shows an example of a SAGD/thermodynamics module 400 that can include a variety of modules 404, 408, 412, 416, 420, 424, 428, 432, 436, 440, 444, 448, 452 and 456. While various aspects of the module 400 are described with respect to SAGD, the module 400 may optionally be implemented without particular SAGD considerations.

In the example of FIG. 4, the thermodynamics module 404 may include instructions that provide for formulating equations pertaining to thermodynamics; the phase/emulsion module 408 may include instructions that provide for formulating equations pertaining to phases and emulsions; the corrosion module 412 may include instructions that provide for formulating equations pertaining to formation of corrosive conditions and corrosion of materials; the scaling module 416 may include instructions that provide for formulating equations pertaining to scaling and characteristics of scales; the burner control module 420 may include instructions that provide for control of one or more aspects of a burner configured to generate steam; the lift control module 424 may include instructions that provide for control of one or more aspects of lift equipment; the fuel/treatments module 428 may include instructions that provide for characterizing fuel and for treating fuel; the cooling water/treatment module 432 may include instructions that provide for characterizing water and for treating water; the separations module 436 may include instructions that provide for characterizing material from a recovery well and for performing separation processes on such material; the equipment materials module 440 may include instructions that provide for characterizing materials of construction of equipment; the equipment dimensions module 444 may include instructions that provide for selecting and assessing dimensions of equipment; the choking/throttling module 448 may include instructions that provide for characterizing choking and throttling operations; the timings module 452 may include instructions that provide for characterizing operational timings associated with recovery of material from a well; and the other module 456 may include other instructions that provide for characterizing aspects of a resource recovery process.

As described herein, the modules of FIG. 4 may optionally be in the form of instructions stored on one or more computer or processor-readable media. For example, such modules may be stored on a drive or other memory and accessed for execution responsive to a call or other command. As described herein, the module 400 may be implemented in a system such as the system 100 of FIG. 1. Specifically, features of the module 400 may be included in the module 160 of FIG. 1. While the module 160 is shown as being included in the modeling loop 104 of FIG. 1, the module 160 may also be configured to receive or transmit information to one or more other components of the system 100 or to one or more other components, for example, associated with design or operation of a resource recovery system or strategy.

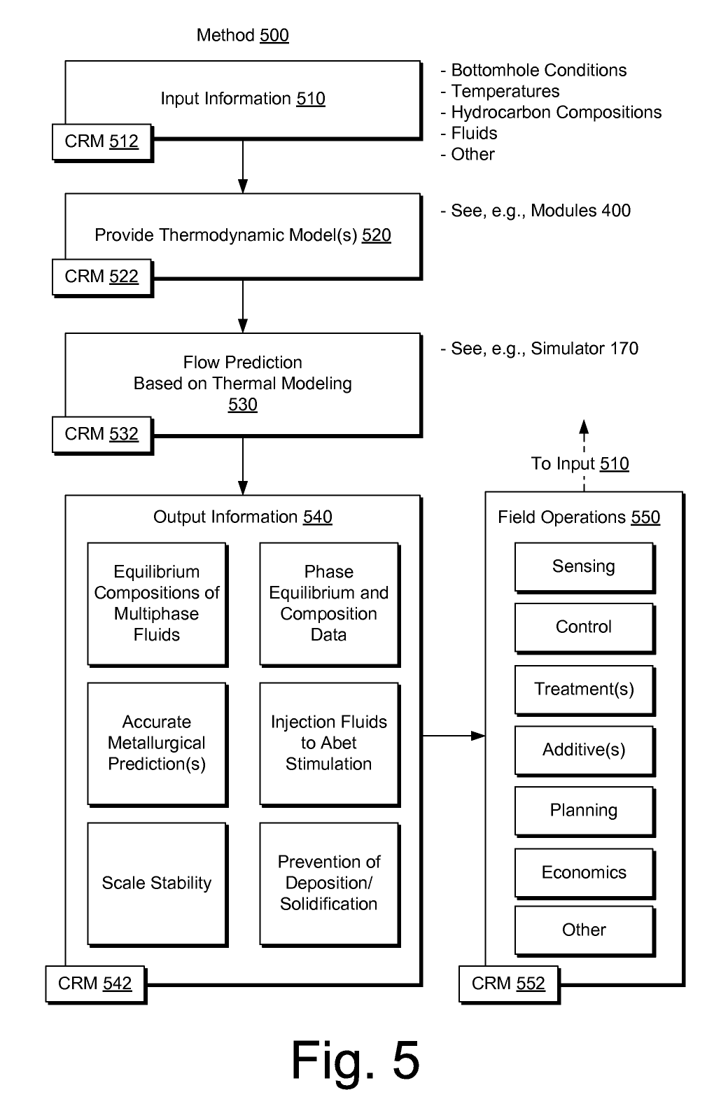

FIG. 5 shows an example of a method 500 that includes thermal simulation for any of a variety of purposes related to a resource recovery system. As shown, the method 500 includes an input block 510 for inputting information, a provision block 520 for providing one or more thermodynamic models, a flow prediction block 530 for predicting flow of material based at least in part on thermal modeling, an output block 540 for outputting information, and a field operations block 550 configured to receive output information. Further, as indicated, consequences of the field operations block 550 may be provided as input of the input block 510. Consequences of the field operations block 550 may include those associated with sensing, control of equipment, treatments, additives, planning, economics, etc.

As to the input block 510, input information may include, for example, information pertaining to bottomhole conditions, temperatures, hydrocarbon compositions, fluids, etc. Such information may optionally be received from one or more sensors or other sources and optionally requested in response to requirements of a thermodynamic model or models. As to the provision block 520, the one or more thermodynamic models may be provided, for example, in the form of a module or modules such as those described with respect to FIG. 4. As to the prediction block 530, a simulator such as the simulator 170 of FIG. 1 may be implemented to predict flow of material where the simulator relies, at least in part, on the provided one or more thermodynamic models. As to examples of output information from the output block 540, such information may include information as to equilibrium of compositions of multiphase fluids, phase equilibrium and composition data, accurate metallurgical predictions, injection fluids to abet stimulation, scale stability, prevention of deposition or solidification of materials, etc. As mentioned, such output information may be transmitted to or accessed by a field operations block and relied upon to take further action (e.g., control of equipment, etc.).

As described herein, in the example of FIG. 5, the method 500 can include simulating fluid thermodynamics of a resource recovery system and a resource reservoir via the flow prediction block 530, based at least in part on the simulating, outputting information as to phase composition in at least one dense phase and in at least the resource recovery system via the output block 540, and, based at least in part on the outputting, controlling equipment of the resource recovery system for recovering a resource from the resource reservoir via the field operations block 550. As described herein, the output block 550 can include outputting information as to phase composition of a resource reservoir responsive to operation of the resource recovery system (see, e.g., feedback to input 510 from the field operations block 550) and the field operations block 550 can include defining an equipment maintenance schedule for a resource recovery system.

In the example of FIG. 5, each of the blocks 510, 520, 530, 540 and 550 has an accompanying computer-readable medium block 512, 522, 532, 542 and 552. As described herein, instructions for implementing the actions of the blocks 510, 520, 530, 540 and 550 may be stored on one or more computer-readable media; noting that the individual computer-readable medium blocks 512, 522, 532, 542 and 552 may be a single computer-readable medium.

As described herein, one or more computer-readable media can include computer-executable instructions to instruct a computing system to receive input as to physical characteristics of a resource recovery system and a resource reservoir (see, e.g., block 512), simulate fluid thermodynamics of the system and the reservoir (see, e.g., block 532), and control equipment of the resource recovery system based at least in part on phase composition in at least one dense phase in the resource recovery system (see, e.g., block 552). As described herein, one or more computer-readable media can include instructions to instruct a computing system to control a steam generator, to control artificial lift equipment, to control treatment equipment configured to treat one or more fluids, to control separation equipment or to control other equipment.

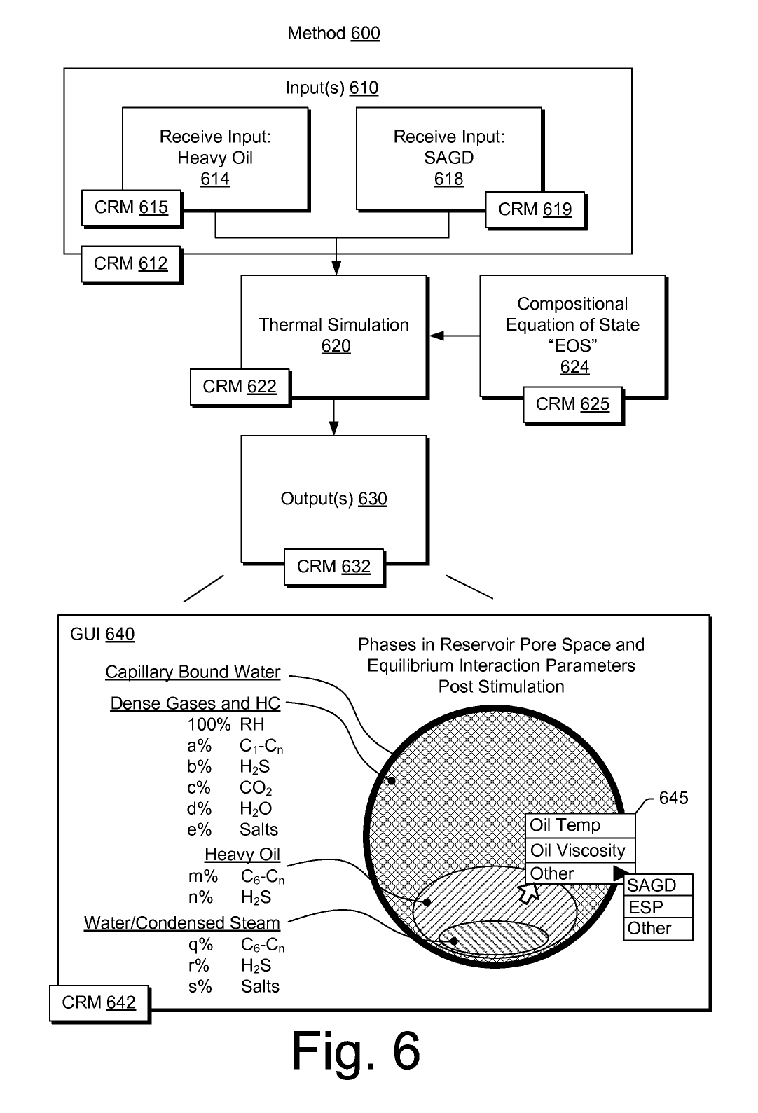

FIG. 6 shows an example of a method 600 for performing a simulation to output information as to phases in a resource recovery system, a resource reservoir or both a resource recovery system and a resource reservoir. As shown, in one or more reception blocks 610, information may be received as to physical characteristics of a resource recovery system and a resource reservoir. In the example of FIG. 6, the reception blocks include a heavy oil block 614 as to characteristics of a resource reservoir and a SAGD block 618 as to characteristics of a resource recovery system. As shown, input information is provided as input to a thermal simulation block 620, which relies on a compositional equation of state (EOS) block 624. As described herein, the simulation block 620 can simulate fluid thermodynamics of the resource recovery system and the resource reservoir. As indicated, the thermal simulation block 620 provides information to an output block 630, which can include, for example, information as to phase composition in at least one dense phase affected by the resource recovery system (e.g., whether in the resource reservoir or the resource recovery system).

As described herein, a dense phase in a resource recovery system generally includes dense gases and hydrocarbons (HC). Such a dense phase may also include water and salts (e.g., inorganic salts, which may be at low or “trace” concentrations). In a resource recovery system, sources of water can include natural water and water condensed from steam, for example, where a SAGD process is implemented. If sour gas is used to generate such steam, then H₂S may also be expected in a dense phase. As described herein, composition of a dense phase can have significant impact on a resource recovery system (e.g., in terms of ability to recover a resource, equipment maintenance, equipment longevity, etc.). Depending on conditions, a dense phase may have a high relative humidity and may be considered aqueous.

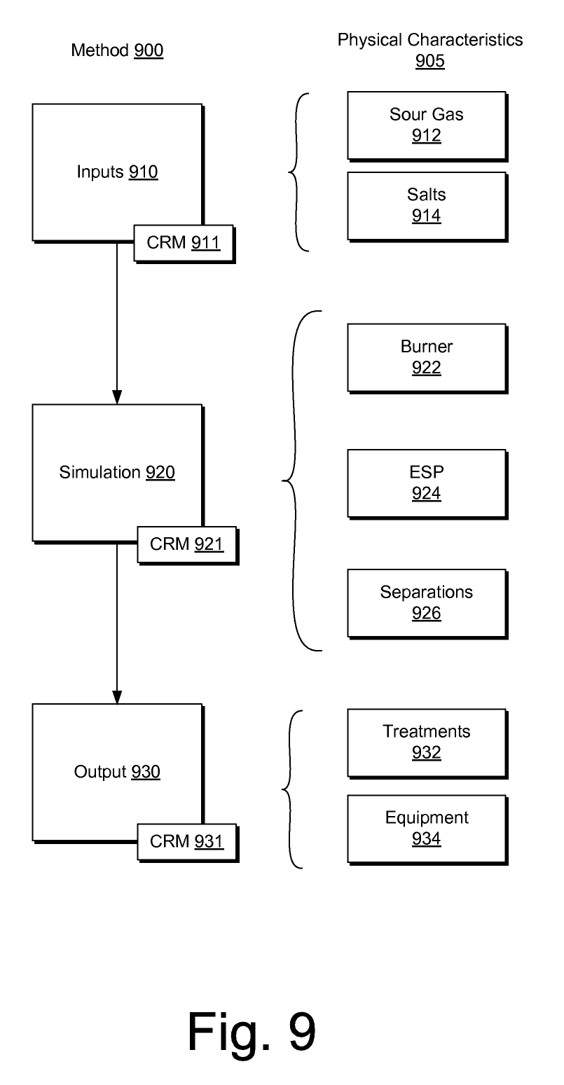

As described herein, output from a thermal simulation may be presented in the form of a graphical user interface (GUI). For example, output information may be output to a graphical user interface to display phase composition, in at least one dense phase, affected by a resource recovery system (e.g., via simulation of a resource recovery system, operation of a resource recovery system, etc.). FIG. 6 shows an example of a GUI 640, which is configured to present phase information for phases in a reservoir pore space and post-simulation interaction parameters. For example, a GUI may present information as to capillary bound water, dense gases and hydrocarbons, heavy oil and water/condensed steam. In the example of FIG. 6, the GUI 640 includes various fields to present H₂S information for various phases (e.g., dense gas and hydrocarbon phase, a heavy oil phase and a water/condensed steam phase). As described herein, the ability to provide such information for a potentially corrosive or otherwise detrimental chemical component can be beneficial for any of a variety of purposes, particularly where the information for the chemical component is provided for multiple phases. In the example of FIG. 6, the GUI 640 can include a field for rendering of salt content (e.g., salt percentage in a phase). Such salts may be organic, inorganic and may be indicative of issues, for example, as described with respect to the example of FIG. 9.

The GUI 640 further includes a menu control 645, for example, to display menu options upon clicking a region of the GUI 640. Such a control may be linked to the particular areas of a graphic that represents composition of a pore space or other space or region in a resource recovery system. For example, a graphic of a portion of a recovery well may be rendered to a display (e.g., optionally including an ESP). In various examples, a user may select a graphical region to initiate rendering of a menu with options for further interaction. In the example shown, by selecting the “heavy oil” region of the graphic, a menu is rendered with options as to oil temperature, oil viscosity and other options where the other options may be to access a SAGD, an ESP or other process, model, graphic, etc. In such a manner, a user can readily assess phases in one region of a modeled recovery system and enter instructions to access other data or controls. For example, if a user wants to increase the percentage of C₆-Cₙ in the heavy oil, the user may link to parameters for a SAGD process or process model and alter one or more of the parameter values in an effort to increase the percentage. As to such processes, the GUI 640 may be configured to issue instructions to alter a parameter value in the field, for example, to adjust flow of an ESP, to adjust rate of steam generated by a steam generator, to adjust a gas treatment process to reduce H₂S concentration in the gas, etc. As described herein, one or more computer-readable media can include instructions to instruct a computing system to render a graphical user interface with phase composition information along with a menu control to select and adjust a physical characteristic of the resource recovery system or the resource reservoir.

In the example of FIG. 6, each of the blocks 610, 614, 618, 620, 624, and 630 and the GUI 640 have an accompanying computer-readable medium block 612, 615, 619, 622, 625, 632 and 642, respectively. As described herein, instructions for implementing the actions of the blocks or GUI may be stored on one or more computer-readable media. Accordingly, the individual computer-readable medium blocks 612, 615, 619, 622, 625, 632 and 642 may be a single computer-readable medium.

As described herein, one or more computer-readable media can include computer-executable instructions to instruct a computing system to receive input as to physical characteristics of a resource recovery system and a resource reservoir, simulate fluid thermodynamics of the resource recovery system and the resource reservoir, and output information as to phase composition in at least one dense phase in the resource recovery system. Such instructions may include instructions to instruct a computing system to receive input as to physical characteristics of a steam generator (e.g., for a SAGD EOR process), to receive input as to physical characteristics of artificial lift equipment (e.g., an ESP), to receive input as to physical characteristics of sour gas, or to receive input as to physical characteristics of heavy oil.

As shown in the example of FIG. 6, one or more computer-readable media can include instructions to instruct a computing system to simulate fluid thermodynamics and to access an equation of state, for example, such as the Helgeson equation of state. Alternatively, or additionally, instructions to instruct a computing system to simulate fluid thermodynamics can include instructions to access an equation of state model fit to measured data.

As described herein, various environments may exist within a resource recovery system, a resource reservoir, or both where pressure exceeds about 10,000 psi and where temperature exceeds about 200 C. Data measured in such an environment or environments may include H₂S solubility data. As described herein, H₂S solubility data may be relied on when fitting an equation of state model. As described herein, instructions can include those to access an equation of state that accounts for supercritical conditions.

As to information generated by a thermal simulation, one or more computer-readable media can include instructions to instruct a computing system to output information, for example, for controlling a resource recovery system, for designing a resource recovery system, for treating a fluid (e.g., gas or liquid), for selecting equipment resistant to a corrosive phase composition in the resource recovery system, etc.

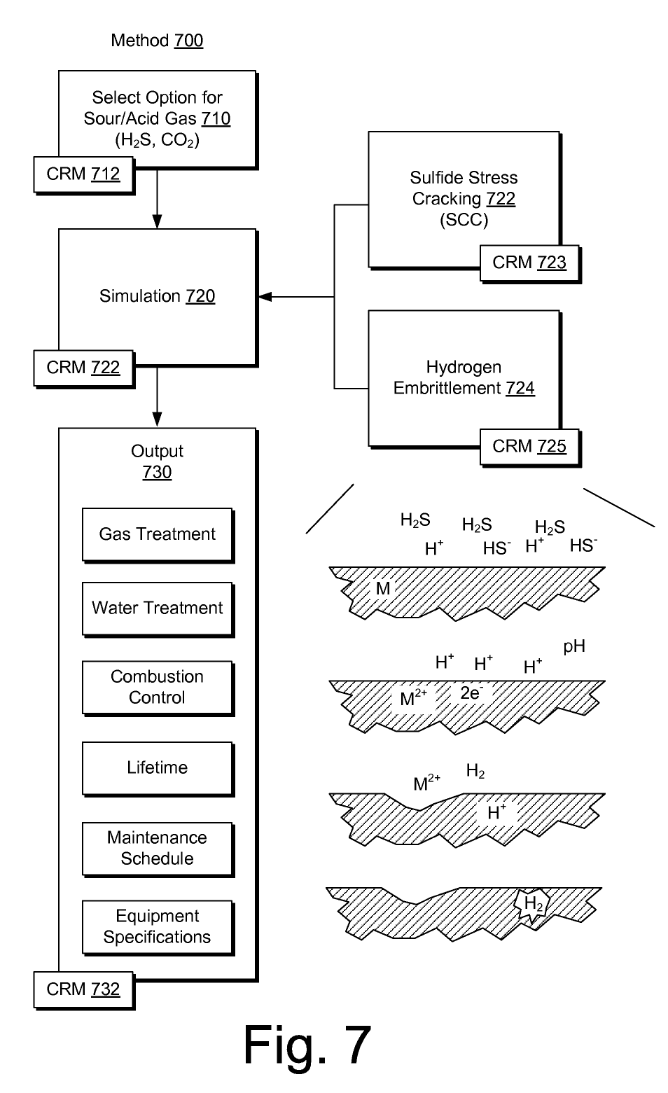

FIG. 7 shows an example of a method 700 for performing a simulation that accounts for sour or acid gas. As shown, the method 700 includes a selection block 710 for selecting an option to account for sour or acid gas (e.g., H₂S, CO₂ or other gas) and a simulation block 720 for performing a simulation that may rely on information from, for example, a sulfide stress cracking block 722 and a hydrogen embrittlement block 724. Based on simulating, an output block 730 provides for outputting information that may be germane to one or more aspects of resource recovery. In the example of FIG. 7, the output block 730 may output information germane to gas treatment (e.g., chemical, filtering, scrubbing, etc.), water treatment (e.g., additives, filtering, etc.), combustion control (e.g., fuel/air ratio, fuel/air flow, temperature), lifetime of equipment (e.g., replacement time for given operational conditions), a maintenance schedule (e.g., for maintenance processes, etc.) and equipment specifications (e.g., for handling conditions associated with sour or acid gas).

In the example of FIG. 7, each of the blocks 710, 720, 722, 724 and 730 has an accompanying computer-readable medium block 712, 722, 723, 725, and 732, respectively. As described herein, instructions for implementing the actions of the blocks may be stored on one or more computer-readable media. Accordingly, the individual computer-readable medium blocks 712, 722, 723, 725, and 732 may be a single computer-readable medium.

As to the hydrogen embrittlement block 724, it may include capabilities as to any of a variety of forms of hydrogen embrittlement where metal comes into contact with atomic or molecular hydrogen. Processes that can lead to hydrogen embrittlement include cathodic protection, phosphating, pickling, and electroplating; further, mechanisms of introducing hydrogen into metal can include galvanic corrosion, chemical reactions of metal with acids (e.g., as a product of CO₂), or with other chemicals, notably hydrogen sulfide in sulfide stress cracking (SSC). As described herein, a SCC block may include information for simulating aspects of H₂S (e.g., reactions, solubility, etc.) where, for example, hydrogen diffusion into a matrix (e.g., metal, alloy, etc.) may be handled by a hydrogen embrittlement block.

As described herein, H₂S can raise various issues as to material integrity. For example, susceptible alloys, especially steels, react with H₂S to form metal sulfides and atomic hydrogen as corrosion byproducts. Atomic hydrogen can combine to form H₂ at a metal surface, which may diffuse into a metal matrix, or within a metal matrix. However, as sulfur is a hydrogen recombination poison, the amount of atomic hydrogen that recombines to form H₂ on a surface may be reduced and thereby increase diffusion of atomic hydrogen into the metal matrix. With respect to diffusion of hydrogen into a metal matrix, formation of metal hydrides can reduce ductility and deformability. In turn, a metal matrix may become brittle and cracking may occur when exposed to tensile stresses.

Sulfide stress cracking (SCC) has particular importance in gas and oil industry, as natural gas and crude oil often contain considerable amount of H₂S. Based on a simulation that accounts for H₂S, equipment may be identified that comes in contact with H₂S and, in turn, be rated for sour service, for example, according to NACE MR0175/ISO 15156 for oil and gas production environments or NACE MR0103 for oil and gas refining environments. Referring to the method 700, the output block 730 may be configured for outputting information identifying regions that come in contact with H₂S and recommending a material of construction, an adjustment to one or more operational parameters, a NACE or ISO standard, etc.

In various instances, perfluoroelastomer materials may be considered or specified in response to a simulation that accounts for sour or acid gas. Perfluoroelastomer components may be able to stand up to severe down-hole conditions from high pressures and temperatures, to aggressive sour gas and corrosive fluids. Such materials may provide for sealing performance superior to other materials. As an example, seals made from KALREZ® material (E. I. Du Pont de Nemours and Company, Wilmington, Del.) may be recommended based on output from a simulation that accounts for H₂S.

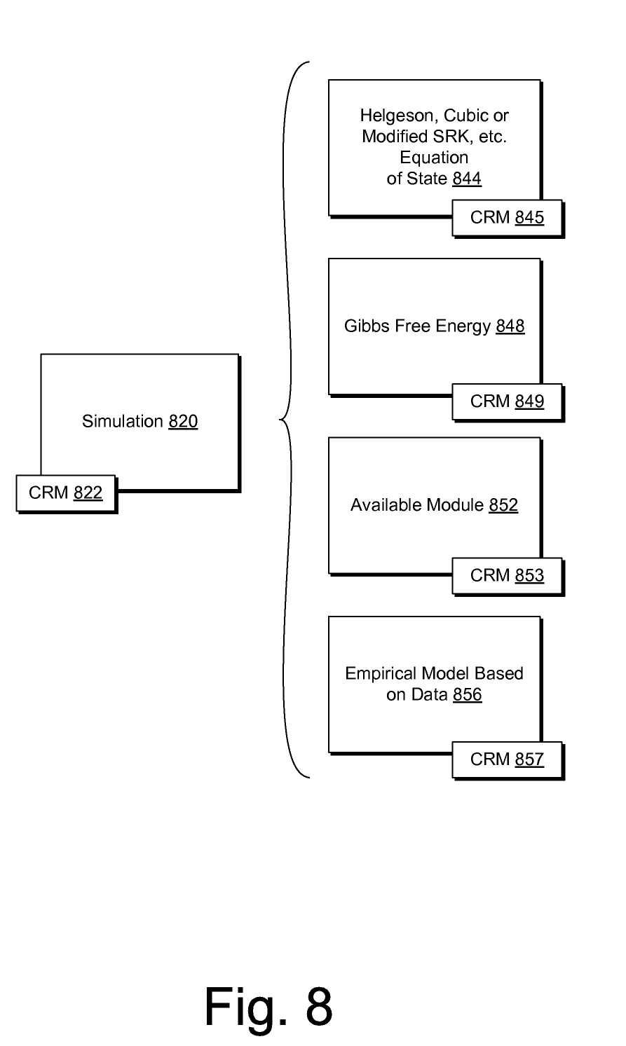

FIG. 8 shows a simulation scheme 800 that includes a simulation module 820 and one or more modules 844, 848, 852 and 856 for providing information such as equation of state. In general, an equation of state is a thermodynamic equation describing the state of matter under a given set of physical conditions. Such an equation may be a constitutive equation that provides for relationships between two or more state functions (e.g., temperature, pressure, volume, or internal energy). Equations of state are useful in describing the properties of fluids, mixtures of fluids, solids, etc.

In the example of FIG. 8, the module 844 provides for a so-called Helgeson equation of state (e.g., optionally Helgeson-Kirkham-Flowers equation of state), cubic equation of state or modified SRK equation of state, the module 848 provides for formulations based on Gibbs free energy analysis, the module 852 provides for access to one or more existing modules (e.g., commercially available, proprietary, etc.), and the module 856 provides for access to one or more empirical models that rely on actual data (e.g., a model fit to sensed data via a regression or other analysis).

In general, as described herein, a module for modeling phases and compositions therein can encompass all true species in solution in both condensed and vapor (dense) phases (complete speciation), handle excess properties relating to activity coefficients (e.g., for dilute systems, to encompass Debye-Huckel complexity), to accommodate phase equilibrium, for example to ascertain that the total Gibbs free energy or chemical potential is equal for phases in equilibrium.

In the example of FIG. 8, each of the blocks 820, 844, 848, 852 and 856 has an accompanying computer-readable medium block 822, 845, 849, 853, and 857, respectively. As described herein, instructions for implementing the actions of the blocks may be stored on one or more computer-readable media. Accordingly, the individual computer-readable medium blocks 822, 845, 849, 853, and 857 may be a single computer-readable medium.

As described herein, a thermodynamic module may provide for a wide range of conditions. For example, a module may account for temperatures from about 0 C to about 600 C and pressures from about 0 psi to about 35,000 psi. As to an equation of state (EOS) framework, such a framework may account for low to high ionic state systems (aqueous solutions) and dense phases encompassing at least H₂S and CO₂. An EOS framework may rely on one or more of Helgeson EOS, cubic EOS, modified SRK EOS and one or more approaches with data regression in a dense phase. An EOS framework may optionally account for all true species in solution in condensed and vapor (e.g., dense) phases (e.g., complete speciation). For excess properties relating to activity coefficients (e.g., dilute systems) a framework may encompass Debye-Huckel complexity. A framework may accommodate phase equilibrium, for example, to ascertain whether total Gibbs free energy or chemical potential is equal for phases in equilibrium.

FIG. 9 shows an example of a method 900 as related to some physical characteristics 905. The method 900 includes an input block 910, a simulation block 920 and an output block 930. As described herein, such a method may include inputting and optionally outputting information as to physical characteristics of conditions, processes or equipment associated with resource recovery. In the example of FIG. 9, the physical characteristics 905 include those for sour gas 912, salts 914, a burner 922, an ESP 924, separations 926, treatments 932 and equipment 934. For example, the input block 910 may include inputting information as to physical characteristics of sour gas 912 and salts 914 (e.g., organic or inorganic salts); the simulation block 920 may include accessing physical characteristics of a burner 922, an ESP 924 and separations 928 (e.g., equipment, processes, etc.); and the output block 930 may include outputting physical characteristics of treatments 932 and equipment 934. Such physical characteristics may be associated with models, for example, where the physical characteristics are parameters of one or more models.

As an example, consider a scenario where a H₂S containing sour gas is available from a reservoir to serve as a fuel to generate steam in a SAGD resource recovery process. In this example, the sour gas may include salt such as NaCl. Accordingly, upon combustion of the sour gas to generate steam, some H₂S and NaCl species will be transported with the steam (e.g., as solvated by water).

In this example, physical characteristics of the sour gas and salt may be provided as inputs. In turn, a simulation that accounts for thermodynamics may rely on these inputs to determine the solubility of the salt in the sour gas under various conditions and optionally determine concentration of H₂S in various phases that may occur throughout the resource recovery process. Such a simulation may rely on burner characteristics, ESP characteristics and optionally separation characteristics, for example, to determine whether the salt, the H₂S or both may impact one or more separation processes as applied to material produced by a well. As to NaCl in sour gas, conditions may exist for various regions in a reservoir, a recovery system or both where the sour gas is initially dissolved in dense, hot, high pressure sour gas and where a change in a state variable can cause precipitation of NaCl (or vice versa).

As to output, the simulation may provide information germane to treatments to treat the sour gas to remove at least some of the salt, the H₂S or both. Additionally, where water provided for steam generation includes dissolved species, these may also be accounted for and one or more treatments may apply to such water. Further, where a simulation indicates that salt, H₂S or both may lead to detrimental conditions (e.g., corrosion, scaling, deposits, etc.), output of a simulation may provide for physical characteristics of equipment to address such detrimental conditions. For example, if scaling due to salt deposition on pipe surfaces is expected to diminish cross-sectional flow area, dimensions may be output to meet desired production requirements. As another example, if a treatment exists to treat scaling, output may specify a treatment schedule to remove scaling and thereby allow for predictable and better management of production. As another example, if corrosion is indicated at a location of an ESP, the output may specify a material of construction of the ESP that avoids or minimizes risk of such corrosion.

As another example, consider a resource recovery operation that includes mechanisms to control corrosion in a deep sour gas well. In such an example, oil containing a corrosion inhibitor may be circulated down an annulus and produced up tubing with the sour gas. In such a system, the oil may be reused and treated with an alkaline solution to remove sulfur, which would otherwise build up in the oil. Such a treatment typically causes some of the alkaline treating solution to remain emulsified in the oil. In such an example, the inhibitor oil can introduce some water containing ions such as Na, HS, S, HCO₃ and CO₃ into a production stream. Accordingly, at a well head, separated water may include a mixture of water condensed from the gas phase, water flowing into the well from the reservoir's surrounding formation and water introduced by the inhibitor oil. As described herein, a simulation that accounts for thermodynamics may include parameters as to salt and salt species transport in a resource recovery system. Such a simulation may identify scaling, depositing, risk of release of scale or deposits, etc., which could impact resource recovery and associated economics.

As described herein, one or more outputs of a simulation may be received by a CAD system, a controller, etc., to impact another process. For example, output to a CAD system may allow a designer to more readily design a robust resource recovery system and output to a controller may allow for control of a burner, an ESP, a treatment process, etc. Transmission of output may occur via a wired or wireless transmission system, where “wired” may be or include optical fiber or another information transport medium.

As described herein, a system can simulate SAGD that allows for a bottom well to produce oil and water that has condensed from the steam. As to production, such a system may rely on one or more of natural flow, gas lift, ESP, and PCP (e.g., all metal construction PCP).

As described herein, one of the issues associated with SAGD is corrosion, especially due to combustion products combined with steam. A burner may be constructed from high nickel corrosion resistant alloys; however, the rest of a completion may require chemical protection. Another challenge with heavy oil is that the mobility is dramatically reduced when it cools off. Plugging of surface flow lines and test equipment and/or downhole test equipment is a potential risk. Also, heavy oil may solidify in pipes as it cools at surface or even downhole if the well is lifted, for example, with nitrogen through coil tubing.

As described herein, conventional techniques for determining fluid properties of typical oil do not usually work very well when applied to heavy oil. Inaccurate measurements of fluid properties may lead to inaccurate rate measurements obtained through multiphase flow meters. As described herein, a simulation system may provide for identification of characteristics such as breakup of water emulsion in heavy oil, for example, to provide for more accurate rate estimates and locating equipment for more accurate measurements.

As described herein, a simulation may characterize a heavy oil reservoir through phase compositions in pore space using thermodynamic modeling to, for example, predict viscosity and interaction parameters with steam or another injection fluid, to predict associated metallurgy and scale stability from the interaction parameters, and to predict how to use injection fluids to abet stimulation of the heavy oil reservoir and formation of an emulsion that can be easily transferred from downhole to surface. Output from a simulation may provide information for harnessing and developing a system to safely produce heavy oil reservoirs having sour gas.

As described herein, a system can include one or more modules for simulating a resource recovery system in relationship to a reservoir. Such a system may be configured to accommodate any of a variety of production techniques (e.g., HPHT even other than SAGD). Such a system may link production and simulation of a HPHT well (e.g., optionally including decline curve analysis etc.) and simulate phase behavior from a reservoir production zone to one or more HP/LP surface separators. As described herein, a system may be configured to predict liquid dropouts near wellbore and along production tubing optionally along with corrosion, equipment compatibility, equipment material selection, etc.

As described herein, a method can include simulating fluid thermodynamics of a resource recovery system and a resource reservoir, based at least in part on the simulating, outputting information as to phase composition in at least one dense phase and in at least the resource recovery system, and, based at least in part on the outputting, controlling equipment of the resource recovery system for recovering a resource from the resource reservoir. In such a method, outputting information can include outputting information as to phase composition of the resource reservoir responsive to operation of the resource recovery system. As described herein, a method can include defining an equipment maintenance schedule for a resource recovery system, for example, based at least in part on a simulation that accounts for at least one dense phase.

As described herein, one or more computer-readable media can include computer-executable instructions to instruct a computing system to receive input as to physical characteristics of a resource recovery system and a resource reservoir, simulate fluid thermodynamics of the system and the reservoir, and control equipment of the resource recovery system based at least in part on phase composition in at least one dense phase in the resource recovery system. As described herein, instructions to control equipment can include instructions to control a steam generator, instructions to control artificial lift equipment, instructions to control treatment equipment configured to treat one or more fluids (e.g., gas or liquid), instructions to control separation equipment, or instructions to control other types of equipment associated with a resource recovery system.

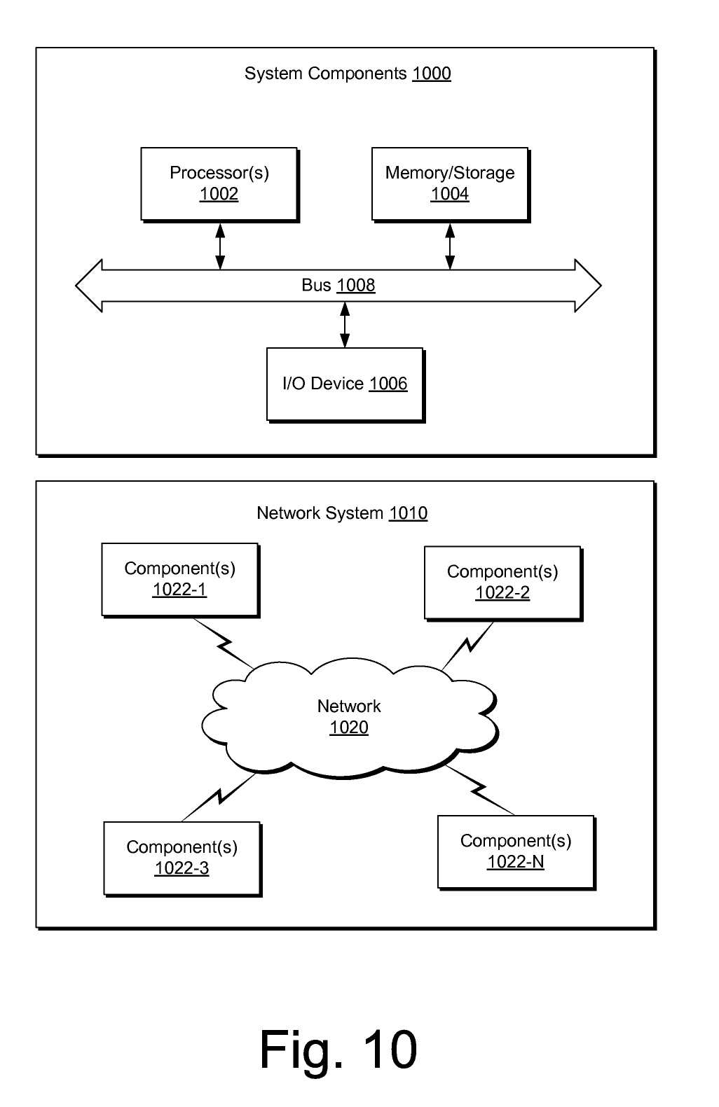

FIG. 10 shows components of a computing system 1000 and a networked system 1010. The system 1000 includes one or more processors 1002, memory and/or storage components 1004, one or more input and/or output devices 1006 and a bus 1008. As described herein, instructions may be stored in one or more computer-readable media (e.g., memory/storage components 1004). Such instructions may be read by one or more processors (e.g., the processor(s) 1002) via a communication bus (e.g., the bus 1008), which may be wired or wireless. The one or more processors may execute such instructions to implement (wholly or in part) one or more virtual sensors (e.g., as part of a method). A user may view output from and interact with a process via an I/O device (e.g., the device 1006).

As described herein, components may be distributed, such as in the network system 1010. The network system 1010 includes components 1022-1, 1022-2, 1022-3, . . . 1022-N. For example, the components 1022-1 may include the processor(s) 1002 while the component(s) 1022-3 may include memory accessible by the processor(s) 1002. Further, the component(s) 1002-2 may include an I/O device for display and optionally interaction with a method. The network may be or include the Internet, an intranet, a cellular network, a satellite network, etc.

### CONCLUSION

Although various methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. One or more computer-readable media comprising computer-executable instructions to instruct a computing system to:
receive input as to physical characteristics of a resource recovery system and a resource reservoir;
simulate fluid thermodynamics of the resource recovery system and the resource reservoir; and
output information to a graphical user interface as to phase composition in at least one dense phase affected by the resource recovery system.

2. The one or more computer-readable media of claim 1 wherein the instructions to instruct a computing system to receive input comprise instructions to receive input as to physical characteristics of a steam generator.

3. The one or more computer-readable media of claim 1 wherein the instructions to instruct a computing system to receive input comprise instructions to receive input as to physical characteristics of artificial lift equipment.

4. The one or more computer-readable media of claim 1 wherein the instructions to instruct a computing system to receive input comprise instructions to receive input as to physical characteristics of sour gas.

5. The one or more computer-readable media of claim 1 wherein the instructions to instruct a computing system to receive input comprise instructions to receive input as to physical characteristics of heavy oil.

6. The one or more computer-readable media of claim 1 wherein the instructions to instruct a computing system to simulate fluid thermodynamics comprise instructions to access an equation of state.

7. The one or more computer-readable media of claim 1 wherein the instructions to instruct a computing system to simulate fluid thermodynamics comprise instructions to access the Helgeson equation of state.

8. The one or more computer-readable media of claim 1 wherein the instructions to instruct a computing system to simulate fluid thermodynamics comprise instructions to access an equation of state model fit to measured data.

9. The one or more computer-readable media of claim 8 wherein the measured data comprises H₂S solubility data for pressures in excess of about 10,000 psi and for temperatures in excess of about 200 C.

10. The one or more computer-readable media of claim 1 wherein the instructions to instruct a computing system to simulate fluid thermodynamics comprise instructions to access an equation of state that accounts for supercritical conditions.

11. The one or more computer-readable media of claim 1 further comprising instructions to instruct a computing system to render the graphical user interface with a menu control to select and adjust a physical characteristic of the resource recovery system or the resource reservoir.

12. The one or more computer-readable media of claim 1 wherein the instructions to instruct a computing system to output information comprise instructions to output equipment information for treating a fluid or selecting equipment resistant to a corrosive phase composition in the resource recovery system.

13. A method comprising:
simulating fluid thermodynamics of a resource recovery system and a resource reservoir;
based at least in part on the simulating, outputting information as to phase composition in at least one dense phase and in at least the resource recovery system; and
based at least in part on the outputting, controlling equipment of the resource recovery system for recovering a resource from the resource reservoir.

14. The method of claim 13 wherein the outputting information comprises outputting information as to phase composition of the resource reservoir responsive to operation of the resource recovery system.

15. The method of claim 13 further comprising defining an equipment maintenance schedule for the resource recovery system.

16. One or more computer-readable media comprising computer-executable instructions to instruct a computing system to:
receive input as to physical characteristics of a resource recovery system and a resource reservoir;
simulate fluid thermodynamics of the resource recovery system and the resource reservoir; and
control equipment of the resource recovery system based at least in part on phase composition in at least one dense phase in the resource recovery system.

17. The one or more computer-readable media of claim 16 wherein the instructions to instruct a computing system to control equipment comprise instructions to control a steam generator.

18. The one or more computer-readable media of claim 16 wherein the instructions to instruct a computing system to control equipment comprise instructions to control artificial lift equipment.

19. The one or more computer-readable media of claim 16 wherein the instructions to instruct a computing system to control equipment comprise instructions to control treatment equipment configured to treat one or more fluids.

20. The one or more computer-readable media of claim 16 wherein the instructions to instruct a computing system to control equipment comprise instructions to control separation equipment.
